(19) United States
(12) Patent Application Publication
(10) Pub. No.: US 2016/0159168 A1
(43) Pub. Date: Jun. 9, 2016

(54) Pneumatic Tire

(71) Applicant: THE YOKOHAMA RUBBER CO., LTD., Tokyo (JP)

(72) Inventor: Isamu Kishizoe, Hiratsuka-shi, Kanagawa (JP)

(21) Appl. No.: 14/900,046

(22) PCT Filed: Jul. 16, 2014
(86) PCT No.: PCT/JP2014/068935

§ 371 Date: Dec. 18, 2015

(30) Foreign Application Priority Data
Jul. 24, 2013 (JP) 2013-153487
Apr. 22, 2014 (JP) 2014-088346

(51) Int. Cl. B60C 19/08; B60C 11/00; B60C 15/06

(52) U.S. Cl. CPC B60C 19/088; B60C 15/06; B60C 19/084; B60C 19/086; B60C 11/0008; B60C 2011/0016

(57) ABSTRACT

The pneumatic tire is provided with: a rim cushion rubber (5A) disposed in a bead portion (5) at a location in contact with a rim (R); and a conductive rubber (11) disposed together with the rim cushion rubber (5A) and having a first end (11a) exposed on the outer surface of the rim cushion rubber (5A) so as to contact the rim (R), and a second end (11b) contacting a tire configuration member (carcass layer (6)) adjacent to the rim cushion rubber (5A). The conductive rubber (11) has an electrical resistance value smaller than that of the rim cushion rubber (5A).

### TECHNICAL FIELD

The present technology relates to a pneumatic tire that can achieve rolling resistance reduction performance and high-speed durability performance, as well as electrical resistance reduction performance.

### BACKGROUND

Conventionally, for example in Japanese Unexamined Patent Application Publication No. 2009-023504A, a pneumatic tire is disclosed that includes a tread portion, a side wall portion, a bead portion, a carcass that extends from the tread portion through the side wall portion to the bead portion, and a breaker disposed on an outer side in the tire radial direction of the carcass. The volume resistivity of the tread rubber, breaker rubber, and side wall rubber formed in the tread portion, the breaker, and the side wall portion respectively is 1×10⁸ Ω·cm or more. Also the pneumatic tire includes a conductive rubber arranged between the carcass plies from which the carcass is configured and the side wall rubber, and between the breaker and the tread portion having a thickness of 0.2 to 3.0 mm, an electro-conductive rubber embedded in the tread portion so that a portion that is connected to the conductive rubber is exposed on the surface of the tread portion, and a clinch arranged in a region of the bead portion in contact with a rim flange and connected to the bottom end of the conductive rubber. The volume resistivity of the conductive rubber, the electro-conductive rubber, and the clinch is less than 1×10⁸ Ω·cm.

Japanese Unexamined Patent Application Publication No. 2009-023504A seeks to effectively discharge static electricity generated between a road surface and a tire during traveling, while maintaining a low rolling resistance. However, the pneumatic tire of Japanese Unexamined Patent Application Publication No. 2009-023504A includes the conductive rubber having a thickness of 0.2 to 3.0 mm between carcass plies from which the carcass is configured and the side wall portion, and between the breaker and the tread portion, and the clinch arranged in the region of the bead portion in contact with the rim flange and connected to the bottom end of the conductive rubber with a volume resistivity of less than 1×10⁸ Ω·cm. In other words, in the pneumatic tire of Japanese Unexamined Patent Application Publication No. 2009-023504A, the conductive rubber between the carcass plies and the side wall rubber, and between the breaker and the tread portion, and the clinch rubber in the region of the bead portion in contact with the rim flange is formed from a rubber material with low electrical resistance. As a result, the rubber material with low electrical resistance has high heat build-up, so it tends to reduce rolling resistance reduction performance and high-speed durability performance.

### SUMMARY

The present technology provides a pneumatic tire that can achieve rolling resistance reduction performance and high-speed durability performance, as well as electrical resistance reduction performance.

A pneumatic tire according to a first aspect includes: a rim cushion rubber provided in a bead portion at a location in contact with a rim; and a conductive rubber disposed together with the rim cushion rubber having a first end thereof exposed on an outer surface of the rim cushion rubber and in contact with the rim, and a second end thereof provided in contact with a tire configuration member adjacent to the rim cushion rubber, and having an electrical resistance value lower than that of the rim cushion rubber.

According to this pneumatic tire, by providing the conductive rubber with a lower electrical resistance value than that of the rim cushion rubber, electricity that enters from the rim flows to the tread portion side through the conductive rubber and the tire configuration member. Therefore, low heat build-up rubber can be adopted for the rim cushion rubber without taking into consideration the electrical resistance value, so the rolling resistance reduction performance and the high-speed durability performance can be improved. As a result, rolling resistance reduction performance and high-speed durability performance and electrical resistance reduction performance can be achieved.

The pneumatic tire according to a second aspect is the first technology in which in a meridian cross-section, the first end of the conductive rubber is disposed on an inner side in a tire radial direction of a horizontal line passing through an end on the inner side in the tire radial direction of a bead core in the bead portion.

In the range on the inner side in the tire radial direction of the horizontal line, the bead core is assembled on the rim so the contact pressure with the rim is high, and even during high speed traveling, contact with the rim is stable. Therefore, according to this pneumatic tire, both rolling resistance reduction performance and high-speed durability performance can be achieved while efficiently reducing the electrical resistance.

The pneumatic tire according to a third aspect is the second technology in which in a meridian cross-section, the second end of the conductive rubber is disposed within the range of ±45° with respect to a normal line to the profile of the bead portion at the position of the first end.

According to this pneumatic tire, by disposing the second end within the range ±45° with respect to the normal line, the increase in volume of the conductive rubber is reduced, so the rolling resistance reduction performance and the high-speed durability performance can be maintained by minimizing heat build-up.

The pneumatic tire according to a fourth aspect is any one of the first to third aspects in which in a meridian cross-section, a width in the thickness direction of the conductive rubber is not less than 0.5 mm and not more than 10.0 mm.

When the width of the conductive rubber is less than 0.5 mm, conductivity is low and the effect of reducing the electrical resistance tends to be small. On the other hand, when the width of the conductive rubber exceeds 10.0 mm, the volume of the conductive rubber is large and the heat build-up is greater, so the rolling resistance reduction performance and the high-speed durability performance tend to be reduced. Therefore, having the width of the conductive rubber not less than 0.5 mm and not more than 10.0 mm is desirable in terms of achieving both rolling resistance reduction performance and high-speed durability performance, as well as electrical resistance reduction performance.

The pneumatic tire according to a fifth aspect is any one of the first to third aspects in which in a meridian cross-section, the width in the thickness direction of the conductive rubber is not less than 0.5 mm and not more than 6.0 mm.

When the width of the conductive rubber is less than 0.5 mm, conductivity is low and the effect of reducing the electrical resistance tends to be small. On the other hand, if the width of the conductive rubber is not more than 6.0 mm, the increase in the volume of the conductive rubber is minimized, and the heat build-up is greatly reduced. Therefore, making the width of the conductive rubber not less than 0.5 mm and not more than 6.0 mm is preferable in terms of achieving both rolling resistance reduction performance and high-speed durability performance, as well as electrical resistance reduction performance.

The pneumatic tire according to a sixth aspect is any one of the first to fifth aspects in which in a meridian cross-section, the width in the thickness direction of the first end of the conductive rubber is greater than the maximum width between the first end and the second end.

By forming the width of the first end of the conductive rubber in contact with the rim wider than the width at an intermediate position, there is excellent entry and exit of electricity as a result of the increased contact area, so a significant effect of reduction of electrical resistance can be obtained.

The pneumatic tire according to a seventh aspect is any one of the first to sixth aspects in which in a meridian cross-section, the width in the thickness direction of the second end of the conductive rubber is greater than the maximum width between the second end and the first end.

By forming the width of the second end of the conductive rubber in contact with the tire configuration member wider than the width at an intermediate position, there is excellent entry and exit of electricity as a result of the increased contact area, so a significant effect of reduction of electrical resistance can be obtained.

The pneumatic tire according to an eighth aspect is any one of the first to seventh aspects in which in a meridian cross-section, the width in the thickness direction of the first end of the conductive rubber is greater than the width of the second end.

Because the width of the first end of the conductive rubber is formed wider than the width of the second end, entry of electricity from the rim R side is excellent, so a significant effect of reduction of electrical resistance can be obtained.

The pneumatic tire according to a ninth aspect is any one of the first to eighth aspects, in which an electrical resistance value is not more than 1×10⁶Ω.

According to this pneumatic tire, electricity easily passes through the conductive rubber, so it is possible to obtain a significant effect of reduction in electrical resistance. On the other hand, the electrical resistance value of the rim cushion exceeds 1×10⁶Ω, so low heat build-up rubber can be adopted, and the rolling resistance reduction performance and the high-speed durability performance can be improved.

The pneumatic tire according to a tenth aspect is any one of the first to ninth aspects, in which the conductive rubber is provided at a plurality of locations.

By providing the conductive rubber at a plurality of locations, a significant effect of reduction in electrical resistance can be obtained.

The pneumatic tire according to an eleventh aspect is any one of the first to tenth aspects, in which the second end of the conductive rubber is provided in contact with a carcass layer as the tire configuration member adjacent to the rim cushion.

According to this pneumatic tire, the carcass layer constitutes the framework for the tire, in which each of the end portions of the carcass layer in the tire width direction are folded from the inner side in the tire width direction to the outer side in the tire width direction at the pair of bead cores, and the carcass layer is wound in the tire circumferential direction to form a toroidal shape. As a result of this configuration, by bringing the second end of the conductive rubber into contact with the carcass layer, the electricity that has entered from the rim can appropriately flow to the tread portion side, and a significant effect of improvement in the reduction in electrical resistance can be obtained.

The pneumatic tire according to a twelfth aspect is any one of the first to tenth aspects, in which the second end of the conductive rubber is provided in contact with an inner liner layer as the tire configuration member adjacent to the rim cushion.

According to this pneumatic tire, the inner liner layer is on the inner circumferential surface of the carcass layer, and each of the both end portions in the tire width direction reaches to the lower portion of the bead core, and is rotated into a toroidal shape in the tire circumferential direction, so by bringing the second end of the conductive rubber in contact with the inner liner layer, the electricity that has entered from the rim can appropriately flow to the tread portion side, and a significant effect of improvement in the reduction in electrical resistance can be obtained. In particular, when the coating rubber of the carcass layer and the side wall rubber of the side wall portion are specified as described above, low heat build-up rubber is adopted for the coating rubber of the carcass layer and the side wall rubber of the side wall portion, so it is possible to obtain a significant effect of improvement in the rolling resistance reduction performance and the high-speed durability performance, and moreover by bringing the second end of the conductive rubber into contact with the inner liner layer, the electricity that has entered from the rim can appropriately flow to the tread portion side, and a significant effect of improvement in the reduction in electrical resistance can be obtained. As a result, rolling resistance reduction performance and high-speed durability performance and electrical resistance reduction performance can be achieved at a higher level.

The pneumatic tire according to a thirteenth aspect is any one of the first to twelfth aspects, in which a loss tangent tan δ at 60° C. of the coating rubber of the carcass layer and the side wall rubber of the side wall portion is not more than 0.12, and the electrical resistance value of the coating rubber of the carcass layer and the side wall rubber of the side wall portion is not less than 1×10⁷Ω.

According to this pneumatic tire, by specifying the coating rubber of the carcass layer and the side wall rubber of the side wall portion as described above, low heat build-up rubber is adopted for the coating rubber of the carcass layer and the side wall rubber of the side wall portion, so it is possible to obtain a significant effect of improvement in the rolling resistance reduction performance and the high-speed durability performance, and moreover the heat sag resistance performance in the high-speed steering stability performance can be improved.

The pneumatic tire according to a fourteenth aspect is any one of the first to thirteenth aspects, in which an earth tread rubber is provided in the tread portion having a first end thereof exposed on an outer surface of the tread portion and a second end thereof provided within the tread portion.

According to this pneumatic tire, by providing the earth tread rubber, the electricity that has entered from the rim can effectively flow to the road surface from the tread surface of the tread portion, so a significant effect of improvement in the reduction in electrical resistance can be obtained. Therefore, low heat build-up rubber can be adopted for the tread rubber, and a significant effect of improvement in the rolling resistance reduction performance and the high-speed durability performance can be obtained.

The pneumatic tire according to the present technology can achieve rolling resistance reduction performance and high-speed durability performance, as well as electrical resistance reduction performance.

### BRIEF DESCRIPTION OF THE DRAWING(S)

FIG. 1 is a meridian cross-sectional view of a pneumatic tire according to an embodiment of the present technology.

FIG. 2 is a meridian cross-sectional view of a pneumatic tire according to an embodiment of the present technology.

FIG. 3 is a partial enlarged view of the pneumatic tire illustrated in FIGS. 1 and 2.

FIG. 4 is a partial enlarged view of the pneumatic tire illustrated in FIGS. 1 and 2.

FIG. 5 is a partial enlarged view of the pneumatic tire illustrated in FIGS. 1 and 2.

FIG. 6 is a partial enlarged view of the pneumatic tire illustrated in FIGS. 1 and 2.

FIG. 7 is a partial enlarged view of the pneumatic tire illustrated in FIGS. 1 and 2.

FIG. 8 is a partial enlarged view of the pneumatic tire illustrated in FIGS. 1 and 2.

FIG. 9 is a graph showing the pressure applied to a bead portion when assembled onto a rim.

FIG. 10 is a partial enlarged view of the pneumatic tire illustrated in FIGS. 1 and 2.

FIG. 11 is a partial enlarged view of the pneumatic tire illustrated in FIGS. 1 and 2.

FIG. 12 is a partial enlarged view of the pneumatic tire illustrated in FIGS. 1 and 2.

FIG. 13 is a partial enlarged view of the pneumatic tire illustrated in FIGS. 1 and 2.

FIG. 14 is a partial enlarged view of the pneumatic tire illustrated in FIGS. 1 and 2.

FIG. 15 is a partial enlarged view of the pneumatic tire illustrated in FIGS. 1 and 2.

FIG. 16 is a partial enlarged view of the pneumatic tire illustrated in FIGS. 1 and 2.

FIG. 17 is a partial enlarged view of the pneumatic tire illustrated in FIGS. 1 and 2.

FIG. 18 is a partial enlarged view of the pneumatic tire illustrated in FIGS. 1 and 2.

FIGS. 19A-19B include a table showing results of performance testing of pneumatic tires according to working examples of the present technology.

FIGS. 20A-20C include a table showing results of performance testing of pneumatic tires according to working examples of the present technology.

### DETAILED DESCRIPTION

An embodiment of the present technology is described below in detail on the basis of the drawings. However, the present technology is not limited to the embodiment. Further, the constituents of the embodiment include constituents that can be easily replaced by those skilled in the art or that are substantially the same as the constituents of the embodiment. Furthermore, a plurality of modified examples described in the embodiment can be combined as desired within the scope of obviousness by a person skilled in the art.

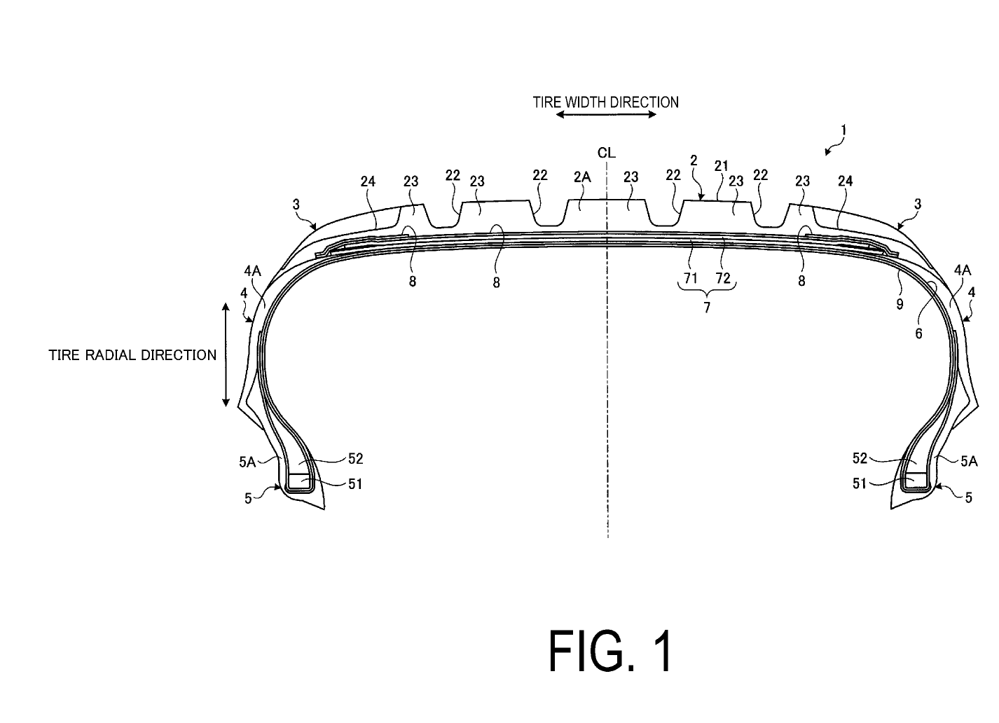

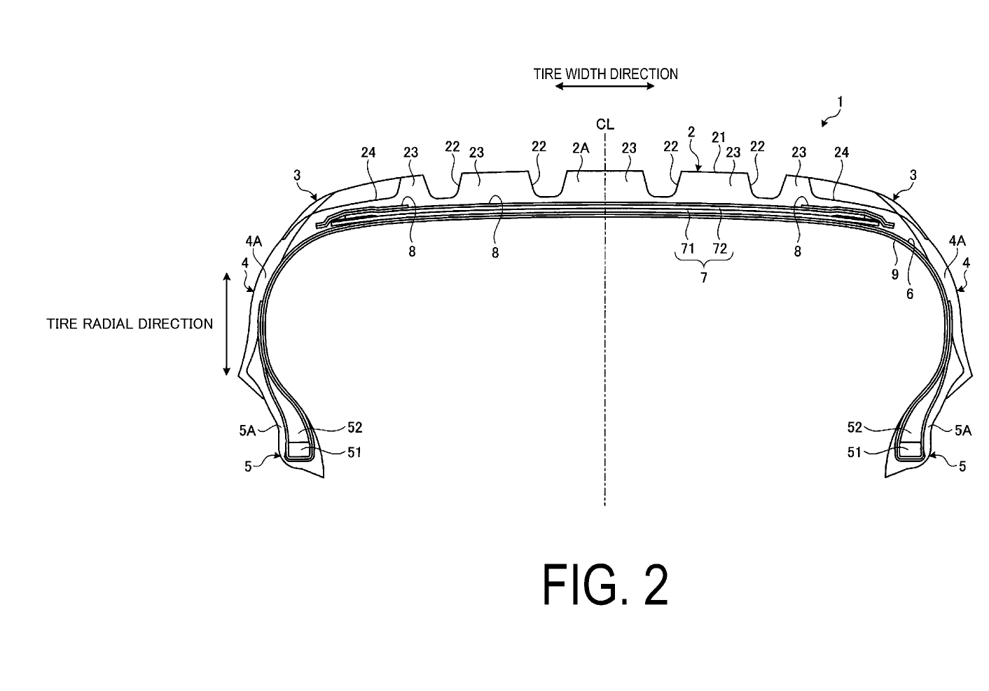

FIGS. 1 and 2 are meridian cross-sectional views of the pneumatic tire according to the present embodiment.

In the following description, “tire radial direction” refers to a direction orthogonal to the rotational axis (not illustrated) of the pneumatic tire 1; “inner side in the tire radial direction” refers to a side facing the rotational axis in the tire radial direction; and “outer side in the tire radial direction” refers to a side distanced from the rotational axis in the tire radial direction. “Tire circumferential direction” refers to a circumferential direction with the rotational axis as a center axis. Additionally, “tire width direction” refers to a direction parallel to the rotational axis; “inner side in the tire width direction” refers to a side facing a tire equatorial plane CL (tire equator line) in the tire width direction; and “outer side in the tire width direction” refers to a side distanced from the tire equatorial plane CL in the tire width direction. “Tire equatorial plane CL” refers to a plane that is orthogonal to the rotational axis of the pneumatic tire 1 and that passes through the center of a tire width of the pneumatic tire 1. The tire width is a width in the tire width direction between constituents located to the outside in the tire width direction, or in other words, the distance between the constituents that are most distant in the tire width direction from the tire equatorial plane CL. “Tire equator line” refers to a line along the tire circumferential direction of the pneumatic tire 1 that lies on the tire equatorial plane CL. In the present embodiment, the tire equatorial line uses the same reference sign CL as the tire equatorial plane.

As illustrated in FIGS. 1 and 2, the pneumatic tire 1 of the present embodiment includes a tread portion 2, shoulder portions 3 on both sides of the tread portion 2, and side wall portions 4 and bead portions 5 continuing sequentially from each of the shoulder portions 3. Additionally, the pneumatic tire 1 includes a carcass layer 6, a belt layer 7, a belt reinforcing layer 8, and an inner liner layer 9.

The tread portion 2 is formed from a tread rubber 2A, is exposed on the outermost side in the tire radial direction of the pneumatic tire 1, and a surface of the tread portion 2 constitutes the profile of the pneumatic tire 1. A tread surface 21 is formed on a peripheral surface of the tread portion 2 or, rather, on a road contact surface that contacts a road surface when traveling. The tread surface 21 has a plurality (four in the embodiments) of main grooves 22 provided therein, extending in the tire circumferential direction, the main grooves 22 being straight main grooves parallel to the tire equatorial line CL. Moreover, a plurality of rib-like land portions 23 extending in the tire circumferential direction is formed in the tread surface 21 by the plurality of main grooves 22. Note that the main grooves 22 may be formed curved or bent while extending along the tire circumferential direction. Also, lug grooves 24 extending in a direction that intersects with the main grooves 22 are provided in the land portions 23 of the tread surface 21. In the present embodiment, the lug grooves 24 are shown in the land portions 23 on the outermost side in the tire width direction. The lug grooves 24 may intersect with the main grooves 22, or at least one end of the lug groove 24 may terminate within the land portion 23 without intersecting the main groove 22. If both ends of the lug grooves 24 intersect the main grooves 22, the land portions 23 are formed into a plurality of block-like land portions in the tire circumferential direction. Note that the lug grooves 24 may be formed bent or curved while extending at an inclination with respect to the tire circumferential direction.

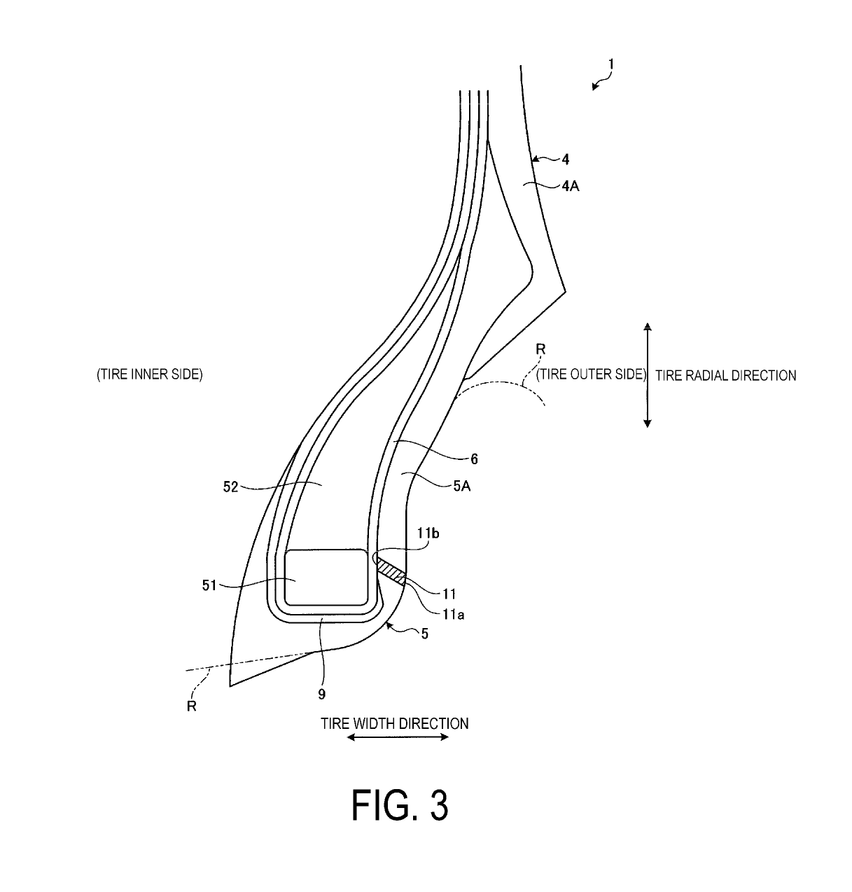

The shoulder portions 3 are located on both outer sides in the tire width direction of the tread portion 2. In other words, the shoulder portions 3 are made from the tread rubber 2A. Additionally, the side wall portions 4 are exposed at an outermost side in the tire width direction of the pneumatic tire 1. The side wall portions 4 are made from a side rubber 4A. As illustrated in FIG. 1, the end portion of the side rubber 4A on the outer side in the tire radial direction is arranged on the inner side in the tire radial direction of the end portion of the tread rubber 2A, and the end portion on the inner side in the tire radial direction is arranged on the outer side in the tire width direction of the end portion of a rim cushion rubber 5A that is described later. Also, as illustrated in FIG. 2, the end portion of the side rubber 4A on the outer side in the tire radial direction may be arranged on the outer side in the tire radial direction of the end portion of the tread rubber 2A extending as far as the shoulder portion 3. The bead portions 5 include a bead core 51 and a bead filler 52. The bead core 51 is formed by winding a steel wire (bead wire) in a ring-like manner. The bead filler 52 is a rubber material that is disposed in a space formed by ends of the carcass layer 6 in the tire width direction being folded up at a position of the bead core 51. The bead portion 5 includes the rim cushion rubber 5A exposed on the outer side portion in contact with a rim R (indicated by a dashed-two dotted line in FIGS. 3 to 8). The rim cushion rubber 5A forms the outer periphery of the bead portion 5, and is provided from the tire inner side of the bead portion 5 through the bottom end portion to a position (side wall portion 4) that covers the bead filler 52 of the tire outer side. Note that in FIGS. 3 to 8, when the pneumatic tire 1 is assembled on the rim R, a portion of the rim cushion rubber 5A on the inner side in the tire radial direction of a bead toe on the tire inner side of the bead portion 5 is pressed against the rim R and deforms.

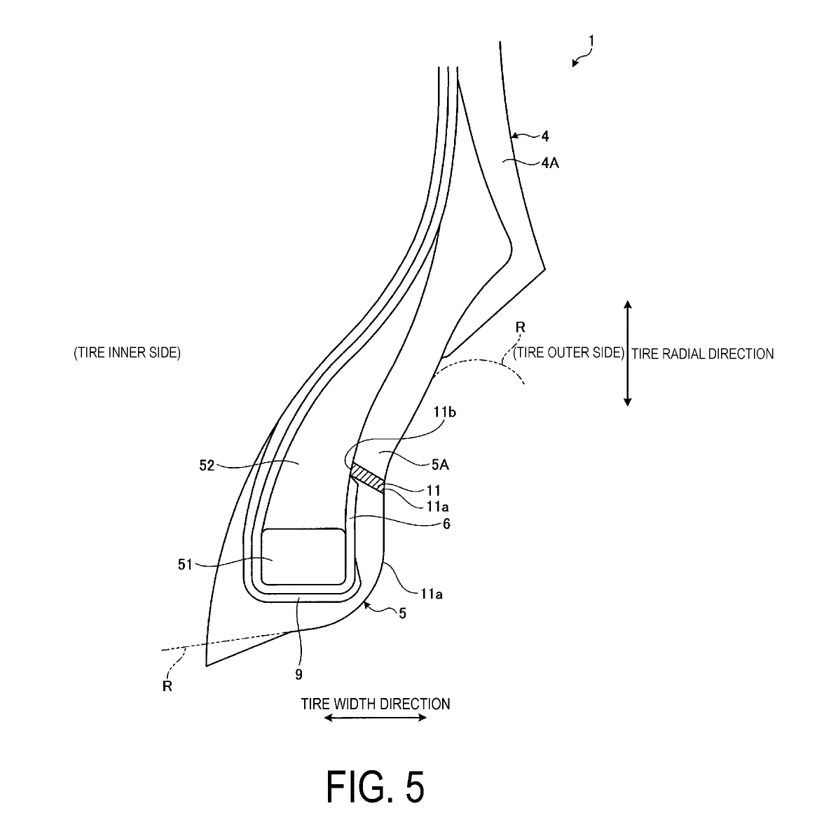

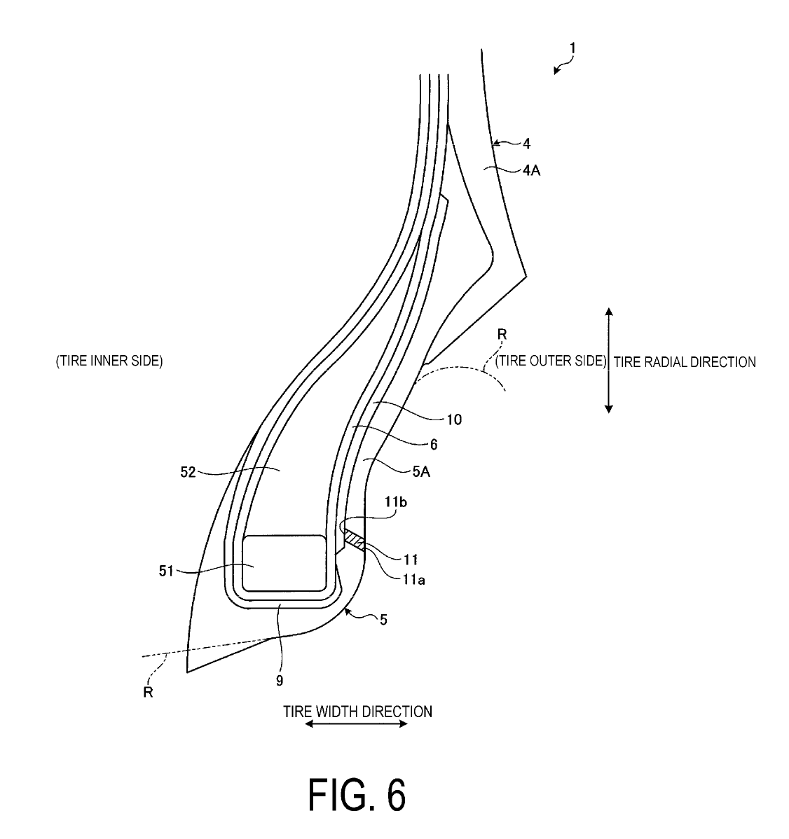

The ends of the carcass layer 6 in the tire width direction are folded over the pair of bead cores 51 from the inner side in the tire width direction to the outer side in the tire width direction, and the carcass layer 6 is stretched in a toroidal shape in the tire circumferential direction to form the framework of the tire. The carcass layer 6 is constituted by a plurality of carcass cords (not illustrated) disposed parallel in the tire circumferential direction along a tire meridian direction at a given angle with respect to the tire circumferential direction and covered by a coating rubber. The carcass cords are formed from organic fibers (e.g. polyester, rayon, nylon, or the like). At least one layer of this carcass layer 6 is provided. Note that in FIGS. 1 and 2, the folded end portion of the carcass layer 6 is provided covering the whole bead filler 52, but the folded end portion may be provided covering the bead filler 52 partially, so that the bead filler 52 is in contact with the rim cushion rubber 5A (see FIG. 5). Also, a steel reinforcing layer 10 (see FIG. 6) in which steel cords are covered with a cord rubber may be provided between the folded portion of the carcass layer 6 on the outer side in the tire width direction and the rim cushion rubber 5A.

The belt layer 7 has a multi-layer structure where at least two layers (belts 71 and 72) are stacked; is disposed on an outer side in the tire radial direction that is the periphery of the carcass layer 6, in the tread portion 2; and covers the carcass layer 6 in the tire circumferential direction. The belts 71 and 72 are constituted by a plurality of cords (not illustrated) juxtaposed at a predetermined angle with respect to the tire circumferential direction (e.g. from 20 to 30 degrees), and covered by a coating rubber. The cords are formed from steel or organic fibers (e.g. polyester, rayon, nylon, or the like). Moreover, the overlapping belts 71 and 72 are disposed so that the cords thereof mutually cross.

The belt reinforcing layer 8 is disposed on the outer side in the tire radial direction that is the periphery of the belt layer 7, and covers the belt layer 7 in the tire circumferential direction. The belt reinforcing layer 8 is constituted by a plurality of cords (not illustrated), juxtaposed in the tire width direction and substantially parallel (±5 degrees) to the tire circumferential direction, which are covered by a coating rubber. The cords are formed from steel or organic fibers (e.g. polyester, rayon, nylon, or the like). The belt reinforcing layer 8 illustrated in FIGS. 1 and 2 is provided covering the whole belt layer 7, and is arranged and layered so as to cover the end portion in the tire width direction of the belt layer 7. The configuration of the belt reinforcing layer 8 is not limited to that described above. For example, a configuration having two layers arranged so as to cover the whole of the belt layer 7, or a configuration arranged to cover only the end portions in the tire width direction of the belt layer 7 may be used. Also, although not illustrated on the drawings, for example, the configuration of the belt reinforcing layer 8 may have one layer arranged to cover the whole belt layer 7, or arranged so as to cover only the end portions in the tire width direction of the belt layer 7. In other words, the belt reinforcing layer 8 overlaps with at least the end portions in the tire width direction of the belt layer 7. Additionally, the belt reinforcing layer 8 is provided by winding band-like (e.g. with a width of 10 mm) strip material in the tire circumferential direction.

The inner liner layer 9 is applied to the tire inner surface, in other words to the inner peripheral surface of the carcass layer 6, with each of the both end portions in the tire width direction extending as far as the position of the bead cores 51 of the pair of bead portions 5, and extending in the tire circumferential direction in a toroidal shape. The inner liner layer 9 is provided to prevent permeation of air molecules to the tire outer side. Note that in FIGS. 1 and 2, the inner liner layer 9 is provided as far as the lower portion of the bead core 51 (the inner side in the tire radial direction), but it may be provided in proximity to the bead core 51 on the tire inner side of the bead portion 5.

FIGS. 3 to 8 are partial enlarged views of the pneumatic tire illustrated in FIGS. 1 and 2.

In the pneumatic tire 1 as described above, a conductive rubber 11 is provided in the rim cushion rubber 5A, as illustrated in FIGS. 3 to 8. The conductive rubber 11 is disposed in the rim cushion rubber 5A, with a first end 11a that is a portion in contact with the rim R exposed on the outer surface (tire outer side: the outer side in the tire width direction of the bead portion 5) of the rim cushion rubber 5A, and a second end l lb provided in contact with a tire configuration member adjacent to the rim cushion rubber 5A. Also, the conductive rubber 11 is formed from a rubber material which has a lower electrical resistance value than that of the rim cushion rubber 5A. The conductive rubber 11 may be provided continuously or it may be provided intermittently in the tire circumferential direction.

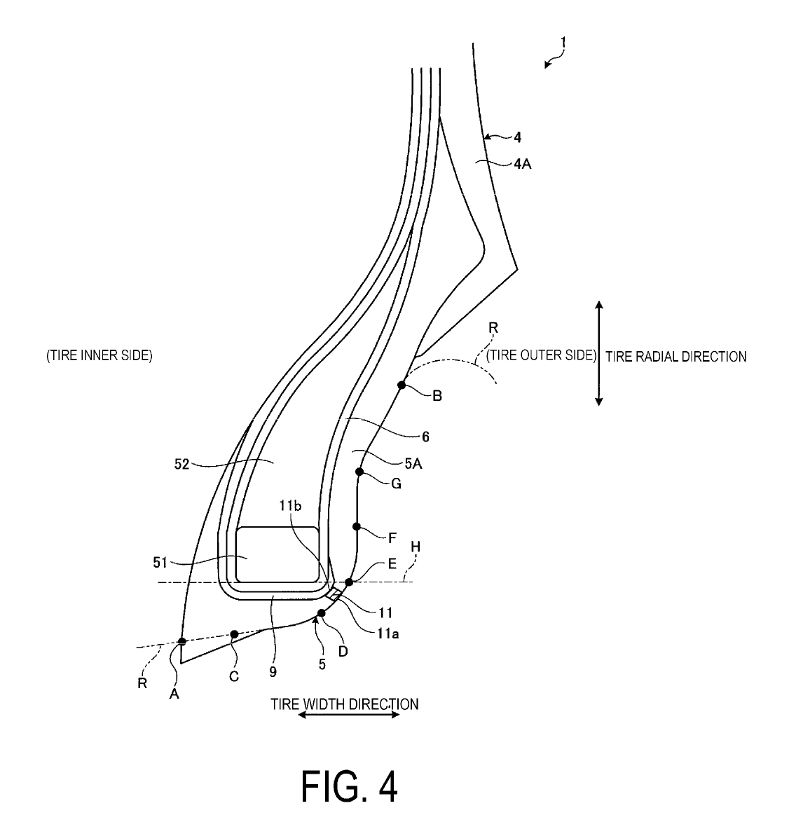

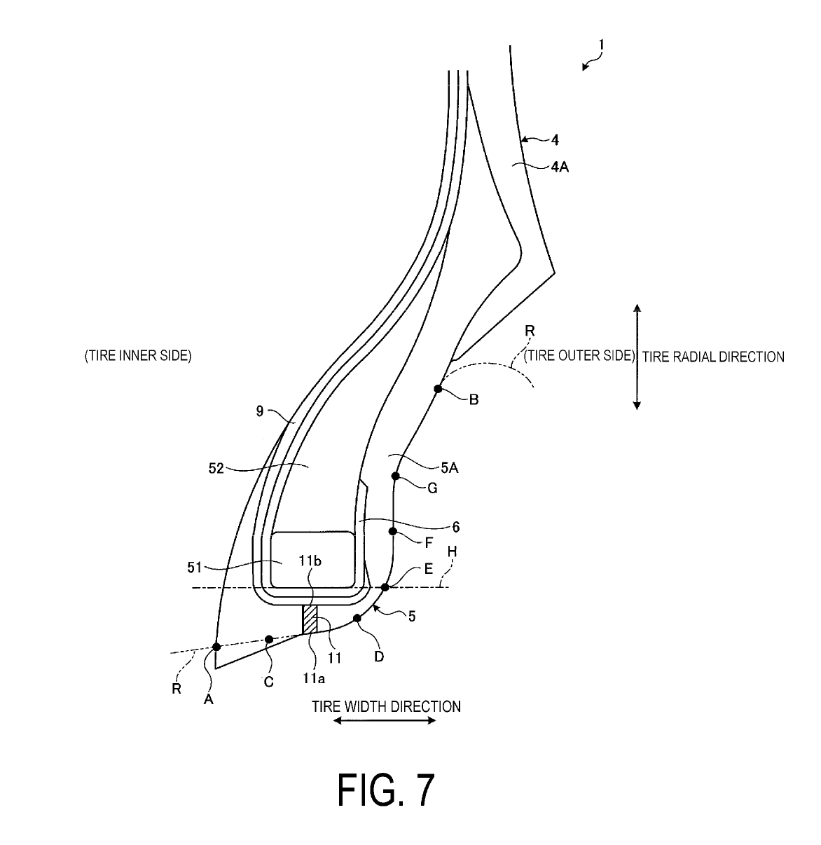

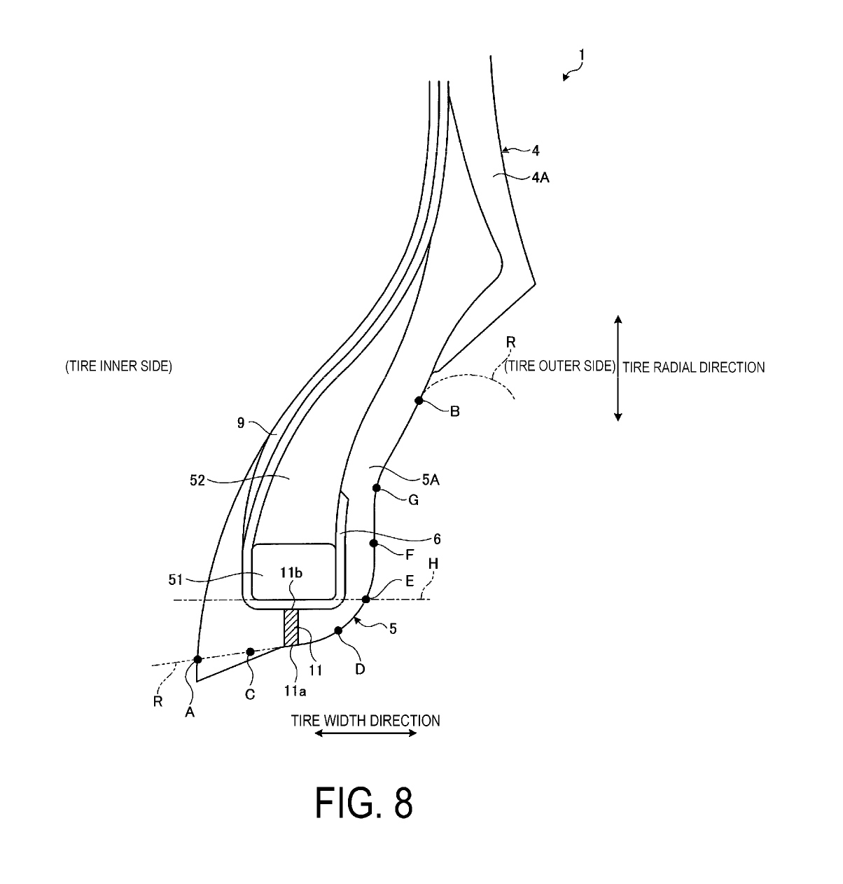

The tire configuration member adjacent to the rim cushion rubber 5A is the carcass layer 6 in FIGS. 3 and 8, the inner liner layer 9 in FIGS. 4 and 7, the bead filler 52 in FIG. 5, and the steel reinforcing layer 10 in FIG. 6.

In this way, the pneumatic tire 1 according to the present embodiment includes the rim cushion rubber 5A provided at a position of the bead portion 5 in contact with the rim R, and the conductive rubber 11 disposed in the rim cushion rubber 5A with the first end 11a thereof exposed on the outer surface of the rim cushion rubber 5A and in contact with the rim R, and the second end 11b provided in contact with the tire configuration member adjacent to the rim cushion rubber 5A, and having an electrical resistance value that is lower than that of the rim cushion rubber 5A.

According to this pneumatic tire 1, by providing the conductive rubber 11 with a lower electrical resistance value than that of the rim cushion rubber 5A, electricity that enters from the rim R flows to the tread portion 2 side through the conductive rubber 11 and the tire configuration member. Therefore, low heat build-up rubber can be adopted for the rim cushion rubber 5A without taking into consideration the electrical resistance value, so the rolling resistance reduction performance and the high-speed durability performance can be improved. As a result, rolling resistance reduction performance and high-speed durability performance and electrical resistance reduction performance can be achieved.

Note that in FIGS. 3 to 8, the conductive rubber 11 is in contact with the tire configuration member adjacent to the rim cushion rubber 5A, but it may be in contact with a plurality of the tire configuration members, in order to enable a more significant effect of the electricity that enters from the rim R flowing to the tread portion 2 side through the conductive rubber 11 and the tire configuration members. Also, positioning the conductive rubber 11 so that the first end 11a is exposed on the outer surface of the rim cushion rubber 5A and the second end 11b is in contact with the tire configuration member adjacent to the rim cushion rubber 5A and the distance between the first end 11a and the second end 11b is the shortest distance is preferable from the point of view of obtaining a more significant effect of the electricity that enters the rim R flowing towards the tread portion 2 side through the conductive rubber 11 and the tire configuration member.

Also, in the pneumatic tire 1 according to the present embodiment, as illustrated in FIGS. 4, 7, and 8, preferably in a meridian cross-section, the first end 11a is disposed on the inner side in the tire radial direction from a horizontal line H passing through the end on the inner side in the tire radial direction of the bead core 51 in the bead portion 5.

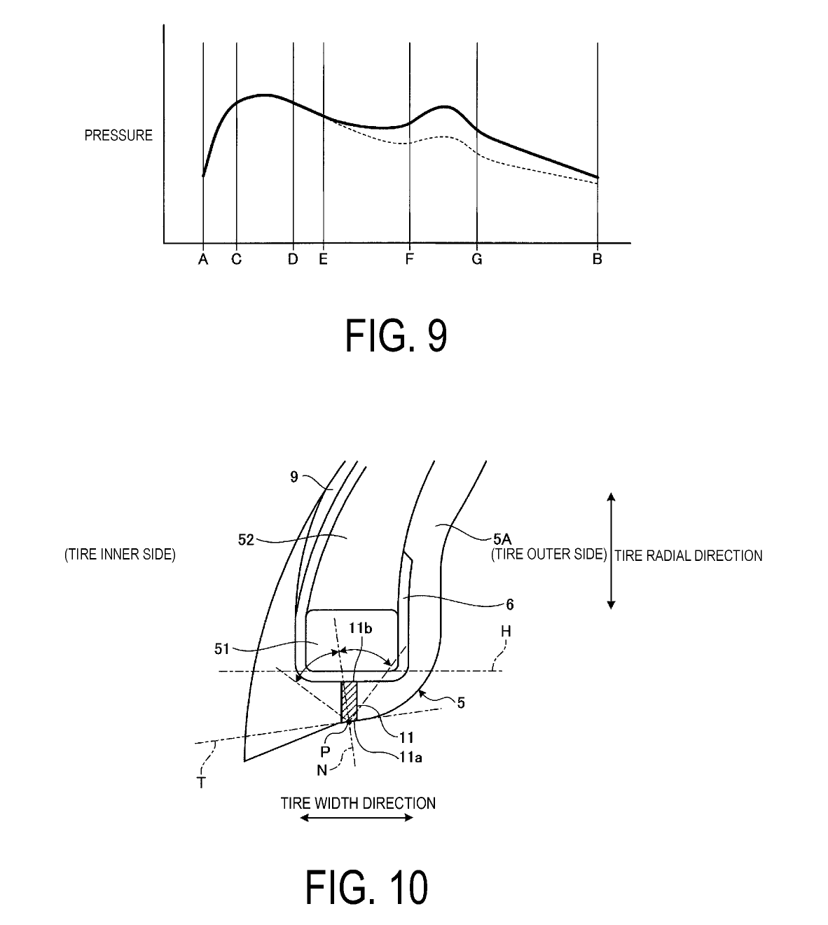

When a meridian cross-section cut sample is fixed corresponding to the rim width of a regular rim that is described later, the horizontal line H is parallel to the tire width direction and perpendicular to the tire equatorial plane CL. Also, in FIGS. 4, 7, and 8, the range of A to B is the range over which the bead portion 5 is in contact with the rim R, when the pneumatic tire 1 is assembled on the rim R. Also, within the range of A to B, the position C is on the inner side in the tire radial direction of the end of the bead core 51 on the tire inner side, the position D is on the inner side in the tire radial direction of the end of the bead core 51 on the tire outer side, the position E is on the horizontal line H, the position F is on the tire outer side of the outer side in the tire radial direction of the bead core 51, and the position G is at the inflection point on the tire outer side of the bead portion 5. FIG. 9 is a graph showing the pressure applied to the bead portion 5 when assembled on the rim, and the pressures at each of the positions within the range of A to B are shown. Also, in FIG. 9, the solid line shows the pressure applied to the bead portion 5 statically (when the vehicle is stopped or traveling at low speed), and the broken line shows the pressure applied to the bead portion 5 during high-speed traveling (150 km/h or more).

As shown in FIG. 9, over the range from the position A to the position E on the inner side in the tire radial direction of the horizontal line H, the contact pressure with the rim R to fit the bead core 51 to the rim R is high, and even during high speed traveling, contact with the rim R is stable. Therefore, by providing the first end 11a of the conductive rubber 11 on the inner side in the tire radial direction of the horizontal line H passing through the end of the bead core 51 on the inner side in the tire radial direction, both rolling resistance reduction performance and high-speed durability performance can be achieved while efficiently reducing the electrical resistance. Note that, as shown in FIG. 9, in the range from the position F to the position G, the contact pressure with the rim R under static conditions is high, but during high-speed traveling, the bead portion 5 can easily be displaced about the bead core 51 as a center, so the contact pressure with the rim R tends to be reduced.

Also, in the pneumatic tire 1 according to the present embodiment, as illustrated in FIG. 10, which is a partial enlarged view of the pneumatic tire 1 illustrated in FIGS. 1 and 2, in a meridian cross-section, preferably the second end 11b is disposed within a range of ±45° with respect to a normal line N to the profile of the bead portion 5 at the position P of the first end 11a of the conductive rubber 11.

As illustrated in FIG. 10, in the state in which the meridian cross-section cut sample is fixed corresponding to the rim width of a regular rim as described later, the position P of the first end 11a is the position of the center of the width in the thickness direction of the first end 11a. The normal line N is perpendicular to the tangent line T to the profile of the bead portion 5 at the position P. Also, by disposing the second end 11b within the range ±45° with respect to the normal line N, the increase in volume of the conductive rubber 11 is reduced, so the rolling resistance reduction performance and the high-speed durability performance can be maintained by minimizing heat build-up.

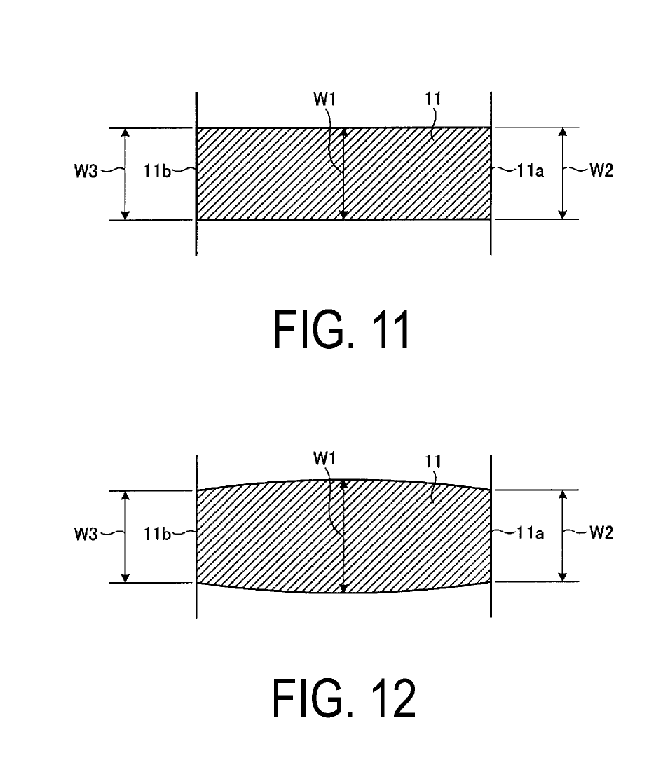

Also, in the pneumatic tire 1 according to the present embodiment, as illustrated in FIGS. 11 to 16 which are partial enlarged views of the pneumatic tire 1 illustrated in FIGS. 1 and 2, preferably the widths W1, W2, W3 of the conductive rubber 11 in the thickness direction in a meridian cross-section are not less than 0.5 mm and not more than 10.0 mm.

The width W1 is the maximum (when the intermediate area widens) or the minimum dimension (when the intermediate area narrows) of an intermediate position between the first end 11a and the second end 11b of the conductive rubber 11, the width W2 is the dimension of the first end 11a of the conductive rubber 11, and the width W3 is the dimension of the second end 11b of the conductive rubber 11.

When the minimum dimension of the widths W1, W2, W3 of the conductive rubber 11 is less than 0.5 mm, the conductivity is low and the electrical resistance reduction effect tends to be reduced. On the other hand, when the maximum dimension of the widths W1, W2, W3 of the conductive rubber 11 exceeds 10.0 mm, the volume of the conductive rubber 11 is large and the heat build-up is greater, so the rolling resistance reduction performance and the high-speed durability performance tend to be reduced. Therefore, having the widths W1, W2, W3 of the conductive rubber 11 not less than 0.5 mm and not more than 10.0 mm is desirable in terms of achieving both rolling resistance reduction performance and high-speed durability performance, as well as electrical resistance reduction performance.

Also, in the pneumatic tire 1 according to the present embodiment, as illustrated in FIGS. 11 to 16, which are partial enlarged views of the pneumatic tire illustrated in FIGS. 1 and 2, preferably the widths W1, W2, W3 in the thickness direction in a meridian cross-section are not less than 0.5 mm and not more than 6.0 mm.

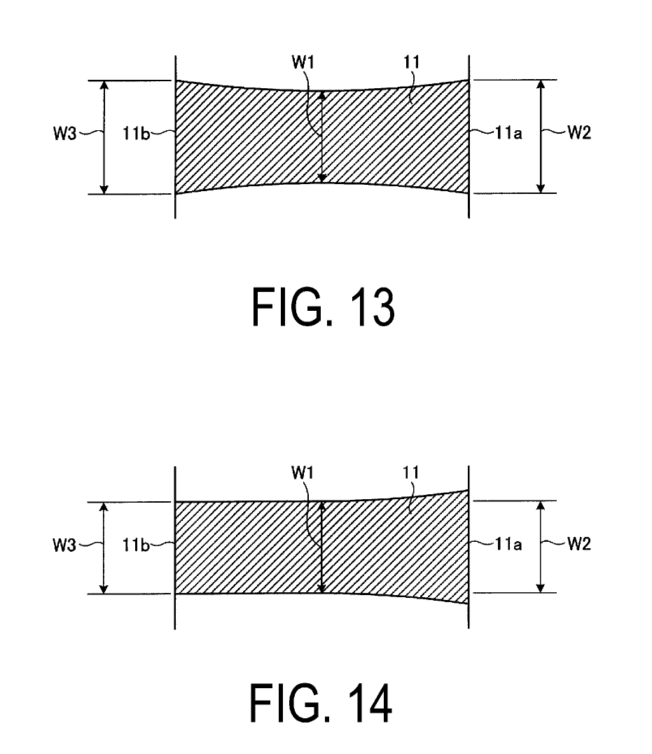

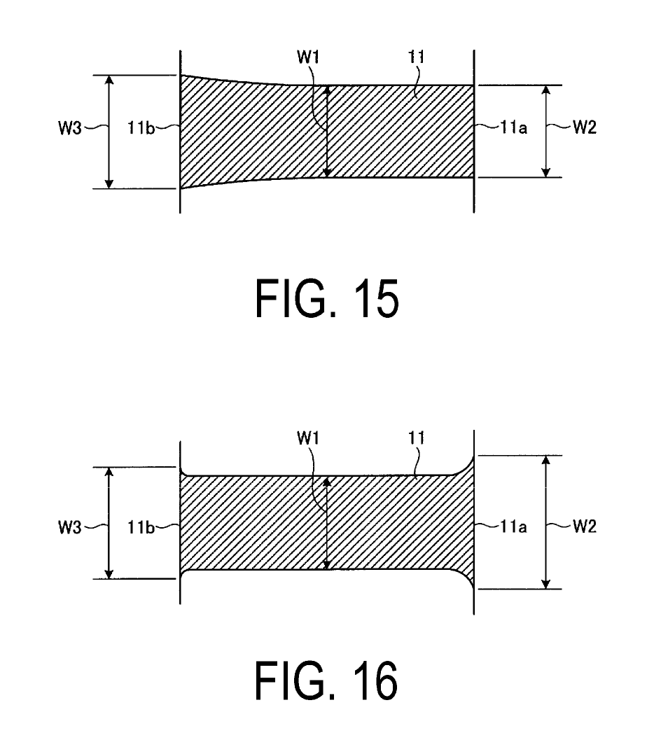

When the dimensions W1, W2, W3 of the conductive rubber 11 is less than 0.5 mm, the conductivity is low and the electrical resistance reduction effect is reduced. On the other hand, if each of the dimensions W1, W2, W3 of the conductive rubber 11 is not more than 6.0 mm, the increase in the volume of the conductive rubber 11 is minimized, and the heat build-up is greatly reduced. Therefore, making the widths W1, W2, W3 of the conductive rubber 11 not less than 0.5 mm and not more than 6.0 mm is preferable in terms of achieving both rolling resistance reduction performance and high-speed durability performance, as well as electrical resistance reduction performance. Here, in FIG. 11, the widths W1, W2, W3 of the conductive rubber 11 from the first end 11a to the second end 11b are illustrated as being formed uniform. Also, in FIG. 12, the width W1 of the conductive rubber 11 is illustrated as being formed wider between the first end 11a and the second end 11b. In the form illustrated in FIG. 12, the widths W2, W3 of the first end 11a and the second end 11b may be not less than 0.5 mm, and the width W1 where it is wider at an intermediate location may be not more than 10.0 mm (preferably not more than 6.0 mm). In the form illustrated in FIG. 12, the width W1 of the conductive rubber 11 is formed wider at an intermediate location, so the electricity can pass more easily and it is possible to obtain a significant effect of reduction in the electrical resistance. Also, in FIG. 13, the widths W2, W3 of the first end 11a and the second end 11b of the conductive rubber 11 are equal and are formed wider than the width W1 at an intermediate location. Also, in FIGS. 14 and 15, one of the width W2 of the first end 11a and the width W3 of the second end 11b of the conductive rubber 11 is formed wider. Also, in FIG. 16, the widths W2, W3 of the first end 11a and the second end 11b of the conductive rubber 11 are formed wider than the width W1 at an intermediate location, and the width W2 of the first end 11a is formed wider than the width W3 of the second end 11b. In the forms illustrated in FIGS. 13 to 16, the width W1 of the intermediate location may be not less than 0.5 mm, and the widths W2, W3 of the first end 11a and the second end 11b may be not more than 10.0 mm (preferably not more than 6.0 mm). In the forms illustrated in FIGS. 13 to 16, the width W2 of the first end 11a and the width W3 of the second end 11b of the conductive rubber 11 that contact either the rim R side or the tire configuration member side are formed wider than the width W1 at an intermediate position, so there is excellent entry and exit of electricity as a result of the increased contact area, so a significant effect of reduction of electrical resistance can be obtained. Moreover, in the form illustrated in FIG. 16, the widths W2, W3 of the first end 11a and the second end 11b of the conductive rubber 11 are formed wider than the width W1 at an intermediate position, and the width W2 of the first end 11a is formed wider than the width W3 of the second end 11b, so entry of electricity from the rim R side is excellent, so a significant effect of reduction of electrical resistance can be obtained.

Therefore, in the pneumatic tire 1 according to the present embodiment, in a meridian cross-section, preferably the width W2 in the thickness direction of the first end 11a of the conductive rubber 11 is greater than the maximum width W1 between the first end 11a and the second end 11b. Also, in a meridian cross-section, preferably the width W3 in the thickness direction of the second end 11b of the conductive rubber 11 is greater than the maximum width W1 between the second end 11b and the first end 11a. In addition, in a meridian cross-section, preferably the width W2 in the thickness direction of the first end 11a of the conductive rubber 11 is greater than the width W3 of the second end 11b.

Also, in the pneumatic tire 1 according to the present embodiment, preferably the electrical resistance value of the conductive rubber 11 is not more than 1×10⁶Ω.

According to this pneumatic tire 1, electricity easily passes through the conductive rubber 11, so it is possible to obtain a significant effect of reduction in electrical resistance. On the other hand, the electrical resistance value of the rim cushion rubber 5A exceeds 1×10⁶Ω, so low heat build-up rubber can be adopted, and the rolling resistance reduction performance and the high-speed durability performance can be improved.

Also, in the pneumatic tire 1 according to the present embodiment, preferably the conductive rubber 11 is provided at a plurality of locations.

By providing the conductive rubber 11 at a plurality of locations, a significant effect of reduction in electrical resistance can be obtained. In this case, as shown in FIG. 9, preferably at least the first end 11a of the conductive rubber 11 is disposed within the range from the position A to the position E or within the range from the position F to the position G, where the contact pressure with the rim R is comparatively high, in order to obtain the effect of reduction of electrical resistance. In particular, providing at least the first end 11a of the conductive rubber 11 at a plurality of locations within the range from the position A to the position E where the contact pressure with the rim R is very high is preferable in order to obtain the effect of reduction in electrical resistance. In addition, providing at least the first end 11a of the conductive rubber 11 at a plurality of locations within the range from the position C to the position D at the lower portion of the bead core 51 (the outer side in the tire radial direction) where the contact pressure with the rim R is very high is more preferable in order to obtain the effect of reduction in electrical resistance.

Also, in the pneumatic tire according to the present embodiment, preferably the second end 11b of the conductive rubber 11 is provided in contact with the carcass layer 6, which is the tire configuration member adjacent to the rim cushion rubber 5A.

According to this pneumatic tire 1, the carcass layer 6 constitutes the framework for the tire, in which each of the end portions of the carcass layer 6 in the tire width direction are folded from the inner side in the tire width direction to the outer side in the tire width direction at the pair of bead cores 51, and the carcass layer 6 is wound in the tire circumferential direction to form a toroidal shape. As a result of this configuration, by bringing the second end 11b of the conductive rubber 11 into contact with the carcass layer 6, the electricity that has entered from the rim R can appropriately flow to the tread portion 2 side, and a significant effect of improvement in the reduction in electrical resistance can be obtained.

Also, in the pneumatic tire 1 according to the present embodiment, preferably the loss tangent tan δ at 60° C. of the coating rubber of the carcass layer 6 and the side rubber 4A of the side wall portion 4 is not more than 0.12, and the electrical resistance value of the coating rubber of the carcass layer 6 and the side rubber 4A of the side wall portion 4 is not less than 1×10⁷Ω Note that the loss tangent tan δ at 60° C. is measured on a specimen sampled from the pneumatic tire 1.

According to this pneumatic tire 1, by specifying the coating rubber of the carcass layer 6 and the side rubber 4A of the side wall portion 4 as described above, low heat build-up rubber is adopted for the coating rubber of the carcass layer 6 and the side rubber 4A of the side wall portion 4, so it is possible to obtain a significant effect of improvement in the rolling resistance reduction performance and the high-speed durability performance, and moreover the heat sag resistance performance in the high-speed steering stability performance can be improved.

Also, in the pneumatic tire according to the present embodiment, preferably the second end 11b of the conductive rubber 11 is provided in contact with the inner liner layer 9, which is the tire configuration member adjacent to the rim cushion rubber 5A.

According to this pneumatic tire 1, the inner liner layer 9 is on the inner circumferential surface of the carcass layer 6, and each of the both end portions in the tire width direction reaches to the lower portion of the bead core 51 of the pair of bead portions 5, and is rotated into a toroidal shape in the tire circumferential direction, so by bringing the second end 11b of the conductive rubber 11 in contact with the inner liner layer 9, the electricity that has entered from the rim R can appropriately flow to the tread portion 2 side, and a significant effect of improvement in the reduction in electrical resistance can be obtained. In particular, when the coating rubber of the carcass layer 6 and the side rubber 4A of the side wall portion 4 are specified as described above, low heat build-up rubber is adopted for the coating rubber of the carcass layer 6 and the side rubber 4A of the side wall portion 4, so it is possible to obtain a significant effect of improvement in the rolling resistance reduction performance and the high-speed durability performance. Moreover by bringing the second end 11b of the conductive rubber 11 into contact with the inner liner layer 9, the electricity that has entered from the rim R can appropriately flow to the tread portion 2 side, and a significant effect of improvement in the reduction in electrical resistance can be obtained. As a result, rolling resistance reduction performance and high-speed durability performance and electrical resistance reduction performance can be achieved at a higher level.

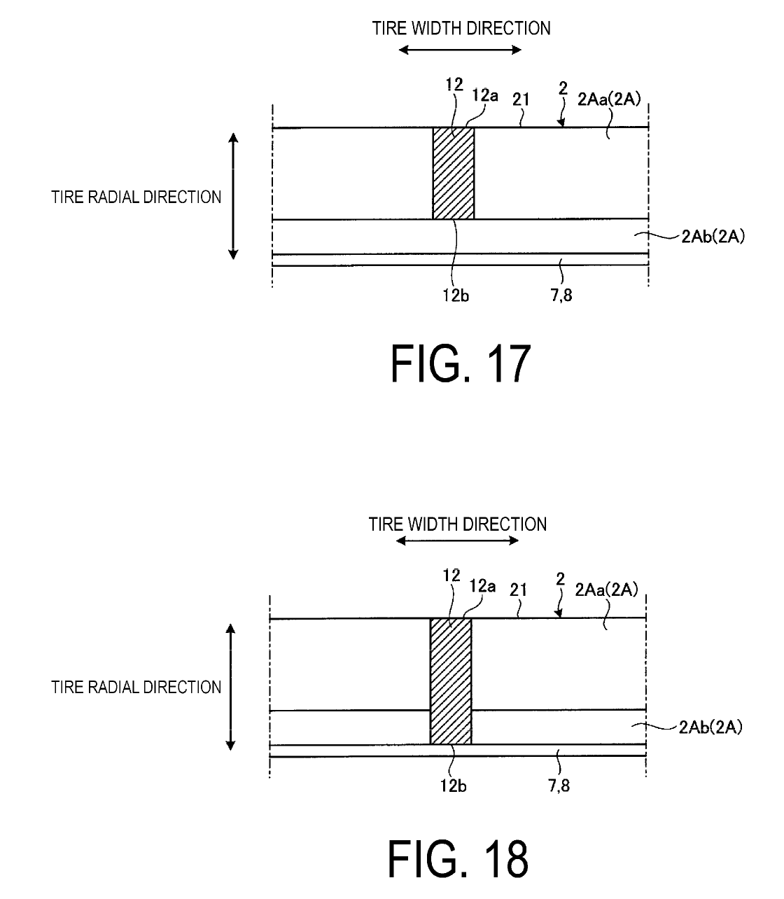

Also, in the pneumatic tire 1 according to the present embodiment, as illustrated in FIGS. 17 and 18, which are partial enlarged views of the pneumatic tire 1 illustrated in FIGS. 1 and 2, preferably the tread portion 2 includes an earth tread rubber 12 provided so that a first end 12a thereof is exposed on the tread surface 21, which is the outer surface of the tread portion 2, and a second end 12b thereof is in the inner portion of the tread portion 2.

According to this pneumatic tire 1, by providing the earth tread rubber 12, the electricity that has entered from the rim R can effectively flow to the road surface from the tread surface 21 of the tread portion 2, so a significant effect of improvement in the reduction in electrical resistance can be obtained. Therefore, low heat build-up rubber can be adopted for the tread rubber 2A, and a significant effect of improvement in the rolling resistance reduction performance and the high-speed durability performance can be obtained.

Here, as illustrated in FIGS. 17 and 18, the tread rubber 2A that forms the tread portion 2 includes a cap tread rubber 2Aa that is exposed on the tread surface 21, and an under tread rubber 2Ab on the inner side in the tire radial direction of the cap tread rubber 2Aa and adjacent to the belt reinforcing layer 8 or the belt layer 7. Also, as illustrated in FIG. 17, the earth tread rubber 12 is provided in the cap tread rubber 2Aa, and the second end 12b is disposed in contact with the under tread rubber 2Ab. Also, as illustrated in FIG. 18, the earth tread rubber 12 may penetrate the under tread rubber 2Ab and the second end 12b may be disposed in contact with the belt reinforcing layer 8 or the belt layer 7. Note that in recent years, the silica compounded amount in the cap tread rubber 2Aa is tending to increase. Silica is an insulating material so it is difficult for the electricity to pass through it. Therefore, by disposing the earth tread rubber 12 so that it penetrates the under tread rubber 2Ab and the second end 12b is in contact with the belt reinforcing layer 8 or the belt layer 7 as illustrated in FIG. 18, the electricity that has entered from the rim R can effectively flow to the road surface from the tread surface 21 of the tread portion 2.

### EXAMPLES

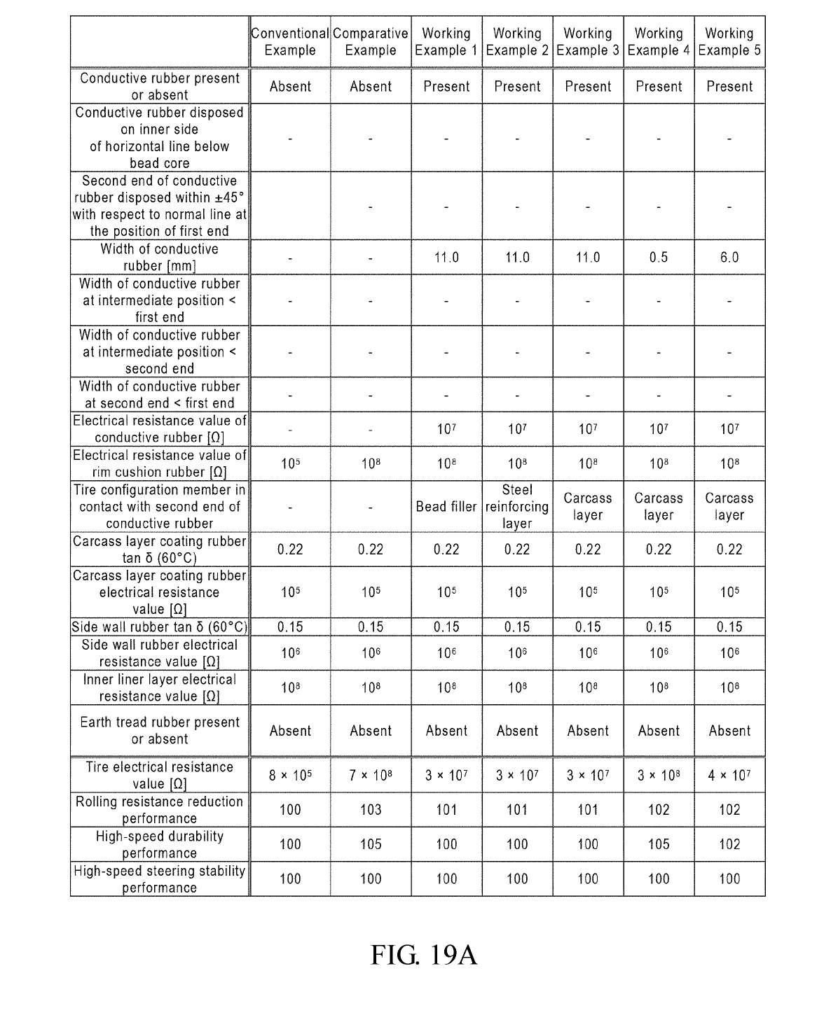

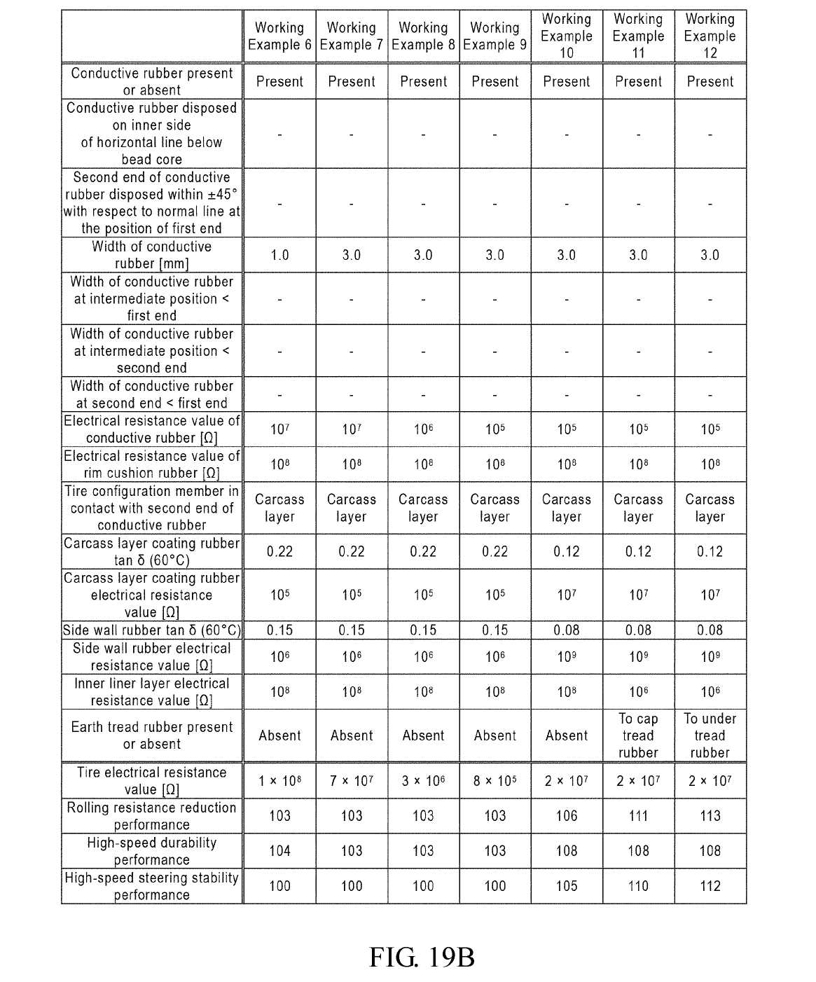

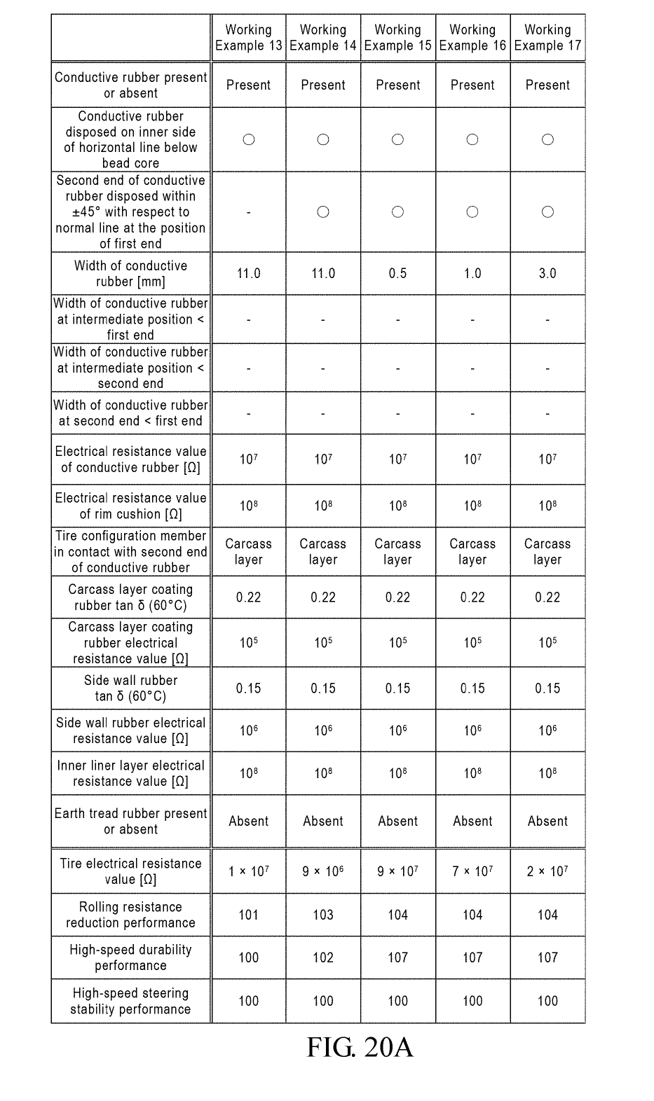

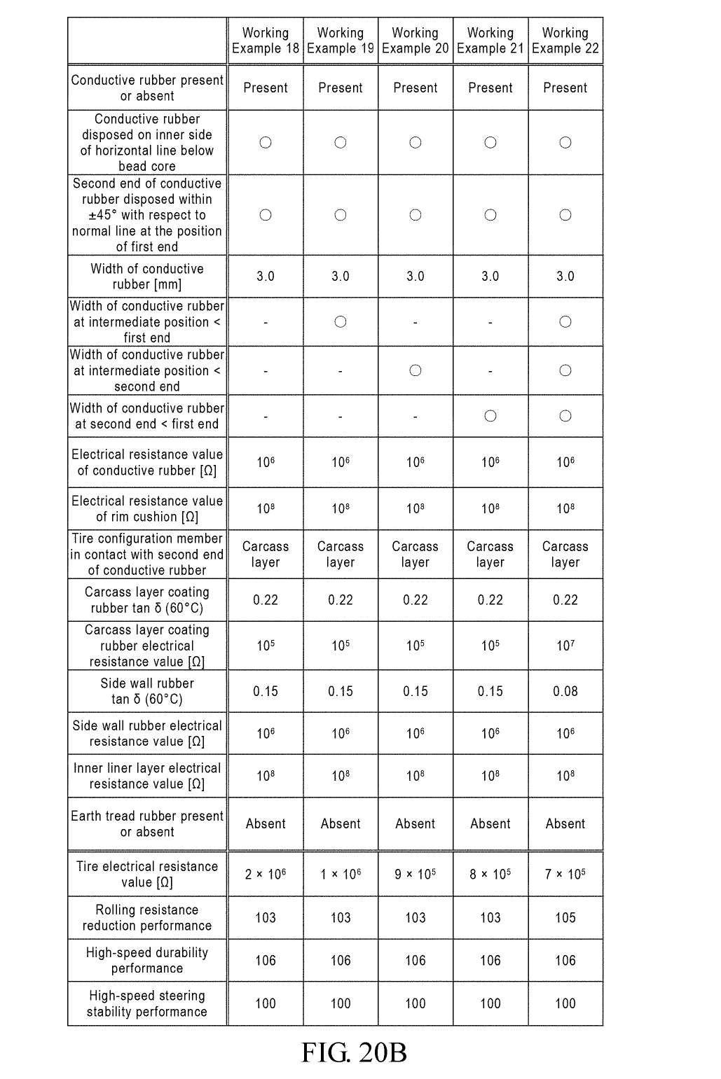

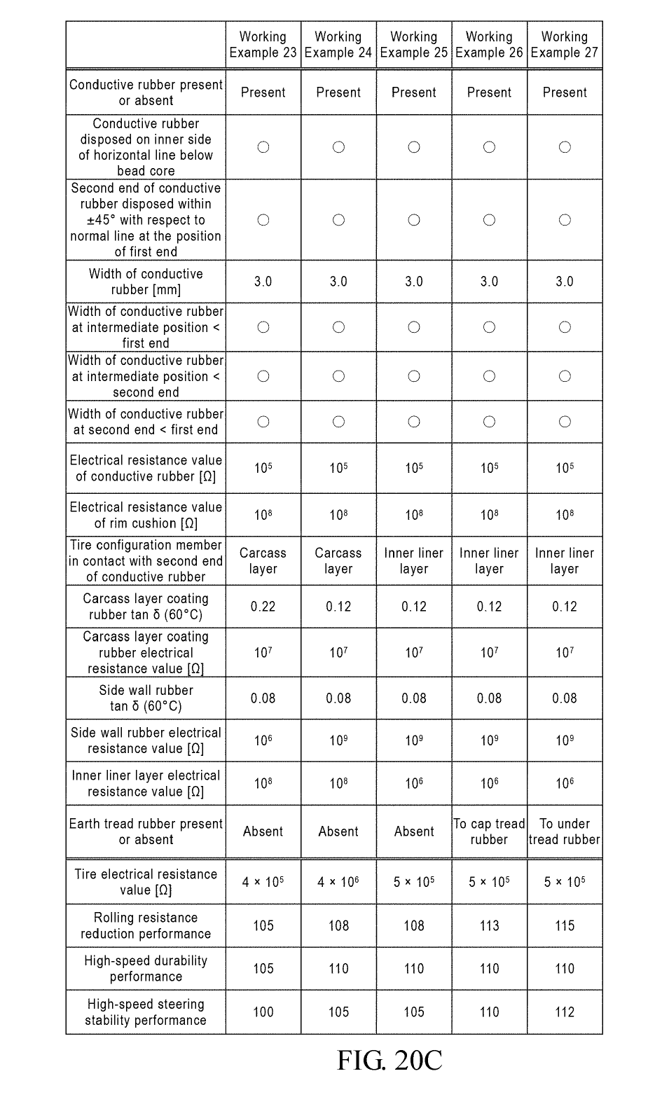

In the present working examples, a plurality of types of pneumatic tires under different conditions were subjected to performance tests for the tire electrical resistance value, which is the electrical resistance reduction performance, the rolling resistance reduction performance, the high-speed durability performance (with camber), the high-speed steering stability performance (heat sag resistance performance) (see FIGS. 19A-19B and 20A-20C).

In these performance tests, pneumatic tires (test tires) with a tire size of 225/45R17 91W were assembled on to a regular rim of 17×7.5J, and inflated to the regular inner pressure (250 kPa).

Here, “regular rim” refers to a “standard rim” defined by the Japan Automobile Tyre Manufacturers Association Inc. (JATMA), a “design rim” defined by Tire and Rim Association, Inc. (TRA), or a “measuring rim” defined by the European Tyre and Rim Technical Organisation (ETRTO). “Regular inner pressure” refers to “maximum air pressure” stipulated by JATMA, a maximum value in “tire load limits at various cold inflation pressures” defined by TRA, and “inflation pressures” stipulated by ETRTO. Note that “regular load” refers to “maximum load capacity” stipulated by JATMA, a maximum value in “tire load limits at various cold inflation pressures” defined by TRA, and “load capacity” stipulated by ETRTO.

The method of evaluation of the tire electrical resistance value, which was the electrical resistance reduction performance, was to apply a voltage of 1000 V under the conditions of temperature 23° C. and humidity 50%, and to measure the resistance value between the tread surface and the rim as the electrical resistance value Q. In this evaluation, the smaller the value, the better the electrical discharge properties, and the better the electrical resistance reduction performance.

The method of evaluation of the rolling resistance reduction performance was to measure the resistance force at a load of 4 kN and a speed of 50 km/h using an indoor drum testing machine. Then, on the basis of the measurement results, index evaluation was performed taking a Conventional Example as a standard (100). In this evaluation, the larger the index, the smaller the rolling resistance, and the better the rolling resistance reduction performance.

The method of evaluation of the high-speed durability included measuring the traveling distance when the tire was damaged under following conditions. The test tire was inflated to an internal pressure 120% of the specified internal pressure, underwent drying degradation for five days in an 80° C. environment, and then set to an internal pressure corresponding to the specified internal pressure. The test driving started at a speed of 120 km/h with a load of 5 kN using a drum test machine with a camber applied with a drum diameter of 1707 mm, and continued until the tire failed with the speed being increased by 10 km/h every 24 hours. Then index evaluation was carried out on the basis of the results, using the Conventional Example as standard (100). In this evaluation, the larger the index, the better the high-speed durability.

The method of evaluation of the high-speed steering stability performance included assembling the test tires to a test vehicle and driving the test vehicle at speeds in the range of 60 to 100 km/h, and evaluation of the steering stability performance by sensory evaluation by experienced drivers for items such as turning stability, rigidity feeling, and steering characteristics when changing lanes and when cornering. Index evaluation against a standard score (100) of a Conventional Example was conducted on the basis of the sensory evaluation. In this evaluation, the greater the index, the better the steering stability performance is.

In FIGS. 19A-19B, the pneumatic tires of the Conventional Example and the Comparative Example did not have the conductive rubber. On the other hand, the pneumatic tires of Working Example 1 to Working Example 12 had the arrangements of FIG. 3 or 5, and the shape of the conductor rubber of FIG. 11. Also, in the pneumatic tires of Working Example 4 to Working Example 12, the width of the conductive rubber was within the specified range. In the pneumatic tires of Working Example 8 to Working Example 12, the electrical resistance value of the conductive rubber was within the specified range. In the pneumatic tires of Working Example 10 to Working Example 12, the loss tangent tan δ at 60° C. and the electrical resistance value of the coating rubber of the carcass layer and the side wall rubber were within the specified range. In the pneumatic tires of Working Example 3 to Working Example 12, the second end of the conductive rubber was in contact with the carcass layer as a tire configuration member. The pneumatic tires of Working Example 11 and Working Example 12 included the earth tread rubber. In the pneumatic tire of Working Example 11, the earth tread rubber was arranged as far as the cap tread rubber, and in the pneumatic tire of Working Example 12, the earth tread rubber was arranged penetrating as far as the under tread rubber.

In FIGS. 20A-20C, in the pneumatic tires of Working Example 13 to Working Example 27, the conductive rubber was provided with the first end arranged on the inner side in the tire radial direction of the horizontal line from the end on the inner side in the tire radial direction of the bead core, with reference to FIG. 7 or 8, and the second end in contact with the carcass layer as a tire configuration member, with reference to FIG. 8 (Working Example 13 to Working Example 24), and the conductive rubber was provided with the second end in contact with the inner liner layer as a tire configuration member with reference to FIG. 7 (Working Example 25 to Working Example 27). Also, in the pneumatic tires of Working Example 15 to Working Example 27, the width of the conductive rubber was within the specified range. In the pneumatic tires of Working Example 18 to Working Example 27, the electrical resistance value of the conductive rubber was within the specified range. In the pneumatic tires of Working Example 19 and Working Example 22 to Working Example 27, the width of the first end of the conductive rubber was greater than that at an intermediate location. In the pneumatic tires of Working Example 20 and Working Example 22 to Working Example 27, the width of the second end of the conductive rubber was greater than that at an intermediate location. In the pneumatic tires of Working Example 21 to Working Example 27, the width of the first end of the conductor rubber was greater than that of the second end. In the pneumatic tires of Working Example 24 to Working Example 27, the loss tangent tan δ at 60° C. and the electrical resistance value of the coating rubber of the carcass layer and the side wall rubber were within the specified ranges. The pneumatic tires of Working Example 26 and Working Example 27 included the earth tread rubber. In the pneumatic tire of Working Example 26, the earth tread rubber was arranged as far as the cap tread rubber, and in the pneumatic tire of Working Example 27, the earth tread rubber was arranged penetrating as far as the under tread rubber.

From the test results of FIGS. 19A-19B and 20A-20C, it can be seen that the pneumatic tires of Working Example 1 to Working Example 27 achieved both rolling resistance reduction performance and high-speed durability performance, and electrical resistance reduction performance as indicated by the tire electrical resistance value. Also the pneumatic tires of Working Example 11, Working Example 12, and Working Example 24 to Working Example 27 had improved high-speed stability performance.

1. A pneumatic tire, comprising:
a rim cushion rubber provided in a bead portion at a location in contact with a rim; and
a conductive rubber disposed together with the rim cushion rubber having a first end thereof exposed on an outer surface of the rim cushion rubber and in contact with the rim, and a second end thereof provided in contact with a tire configuration member adjacent to the rim cushion rubber, and having an electrical resistance value lower than that of the rim cushion rubber.

2. The pneumatic tire according to claim 1, wherein in a meridian cross-section, the first end of the conductive rubber is disposed on an inner side in a tire radial direction of a horizontal line passing through an end on the inner side in the tire radial direction of a bead core in the bead portion.

3. The pneumatic tire according to claim 2, wherein in a meridian cross-section, the second end of the conductive rubber is disposed within a range of ±45° with respect to a normal line to a profile of the bead portion at a position of the first end.

4. The pneumatic tire according to claim 1, wherein in a meridian cross-section, a width in a thickness direction of the conductive rubber is not less than 0.5 mm and not more than 10.0 mm.

5. The pneumatic tire according to claim 1, wherein in a meridian cross-section, a width in a thickness direction of the conductive rubber is not less than 0.5 mm and not more than 6.0 mm.

6. The pneumatic tire according to claim 1, wherein in a meridian cross-section, a width in a thickness direction of the first end of the conductive rubber is greater than the maximum width between the first end and the second end.

7. The pneumatic tire according to claim 1, wherein in a meridian cross-section, a width in a thickness direction of the second end of the conductive rubber is greater than the maximum width between the second end and the first end.

8. The pneumatic tire according to claim 1, wherein in a meridian cross-section, the width in the thickness direction of the first end of the conductive rubber is greater than the width of the second end.

9. The pneumatic tire according to claim 1, wherein an electrical resistance value is not more than 1×10⁶Ω.

10. The pneumatic tire according to claim 1, wherein the conductive rubber is provided at a plurality of locations.

11. The pneumatic tire according to claim 1, wherein the second end of the conductive rubber is provided in contact with a carcass layer as the tire configuration member adjacent to the rim cushion.

12. The pneumatic tire according to claim 1, wherein the second end of the conductive rubber is provided in contact with an inner liner layer as the tire configuration member adjacent to the rim cushion.

13. The pneumatic tire according to claim 1, wherein a loss tangent tan δ at 60° C. of a coating rubber of the carcass layer and a side wall rubber of the side wall portion is not more than 0.12, and an electrical resistance value of the coating rubber of the carcass layer and the side wall rubber of the side wall portion is not less than 1×10⁷Ω.

14. The pneumatic tire according to claim 1, wherein an earth tread rubber is provided in the tread portion having a first end thereof exposed on an outer surface of the tread portion and a second end thereof provided within the tread portion.
